(19) United States
(12) Patent Application Publication
(10) Pub. No.: US 2023/0026467 A1
(43) Pub. Date: Jan. 26, 2023

(54) SYSTEMS AND METHODS FOR AUTOMATED AUDIO TRANSCRIPTION, TRANSLATION, AND TRANSFER FOR ONLINE MEETING

(71) Applicants: SALAH M. WERFELLI, MORGAN HILL, CA (US); KHALED JASSIM J S AL-JABER, DOHA (QA); SULEIMAN KAYED SULEIMAN KHARROUB, DOHA (QA); KHALED MOHAMED ABDELBAKI ABDELHALIM REZK, DOHA (QA)

(72) Inventors: SALAH M. WERFELLI, MORGAN HILL, CA (US); KHALED JASSIM J S AL-JABER, DOHA (QA); SULEIMAN KAYED SULEIMAN KHARROUB, DOHA (QA); KHALED MOHAMED ABDELBAKI ABDELHALIM REZK, DOHA (QA)

(21) Appl. No.: 17/382,143

(22) Filed: Jul. 21, 2021

(51) Int. Cl. G06F 40/58; G10L 15/00; G10L 15/183; G10L 15/22; G10L 15/04; G10L 13/02; G06F 3/0485

(52) U.S. Cl. CPC G06F 40/58; G06F 3/0485; G10L 13/02; G10L 15/04; G10L 15/005; G10L 15/22; G10L 15/183

(57) ABSTRACT

The present invention discloses systems and methods for multimedia processing. For example, the present invention provides systems and methods for receiving spoken audio, converting the spoken audio to text, and transferring the text to a user. As desired, the speech or text can be translated into one or more different languages. Systems and methods for real-time conversion and transmission of speech and text are provided, including systems and methods for large scale processing of multimedia events.

### CROSS REFERENCE OF RELATED PATENT(S OR APPLICATION(S

The current application claims benefit of U.S. Provisional Pat. Application 63/054389 filed Jul. 21, 2020.

### FIELD OF THE INVENTION

The present invention relates to systems and methods for multimedia processing. For example, the present invention provides systems and methods for receiving spoken audio, converting the spoken audio to text, and transferring the text to a user. As desired, the speech or text can be translated into one or more different languages. Systems and methods for real-time conversion and transmission of speech and text are provided, including systems and methods for large scale processing of multimedia events.

### BACKGROUND OF THE INVENTION

In the last few years, improvements in software and hardware have allowed the Internet to be used on a large scale for the transmission of audio and video. Such improvements include the availability of real-time streaming audio and video. Numerous media events are now “broadcast” live over the Internet, allowing users to see and hear speeches, music events, and other artistic performances. With further increases in speed, the Internet promises to be the primary method for transmitting and receiving multimedia information.

Present real-time applications, however, are limited in their flexibility and usefulness. For example, many real-time audio and video application do not permit users to edit or otherwise manipulate the content.

The art is in need of new systems and methods for expanding the usefulness and flexibility of multimedia information flow over electronic communication systems.

### DETAILED DESCRIPTION OF THE INVENTION

The present invention comprises systems and methods for providing text transcripts of multimedia events. For example, text transcripts of live or pre-recorded audio events are generated by the systems and methods of the present invention. The audio may be a component of a more complex multimedia performance, such as televised or motion picture video. Text transcripts are made available to viewers either as pure text transcripts or in conjunction with audio or video (e.g., audio or video from which the text was derived). In some preferred embodiments of the present invention (e.g., for live events), text is encoded in an information stream and streamed to a viewer along with the audio or video event. In some such embodiments, the text is configured to be viewable separate from the media display on a viewer’s computer. In yet other preferred embodiments, the text is provided to the viewer in a manner that allows the viewer to manipulate the text. Such manipulations include copying portions of the text into a separate file location, printing the text, and the like.

The systems and methods of the present invention also allow audio to be translated into one or more different languages prior to delivery to a viewer. For example, in some embodiments, audio is converted to text and the text is translated into one or more desired languages. The translated text is then delivered to the viewer along with the original audio-containing content. In some embodiments, the text is re-converted to audio (e.g., translated audio) and the audio is streamed to the viewer, with or without the text transcript.

The systems and methods of the present invention find use in numerous applications, including, but not limited to, the generation of text from live events (e.g., speeches), televised events, motion pictures, live education events, legal proceedings, text for hearing impaired individuals, or any other application where a speech-to-text or audio-to-text conversion is desired.

All publications and patents mentioned in the above specification are herein incorporated by reference. Various modifications and variations of the described methods and systems of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the present invention.

The present invention relates to systems and methods for multimedia processing. For example, the present invention provides systems and methods for receiving spoken audio, converting the spoken audio to text, and transferring the text to a user. As desired, the speech or text can be translated into one or more different languages. Systems and methods for real-time conversion and transmission of speech and text are provided.

For example, the present invention provides Web-enabled systems comprising audio-to-text captioning capabilities, audio conference bridging, text-to-speech conversion, foreign language translation, web media streaming, and voice-over-IP integrated with processing and software capabilities that provide streaming text and multimedia information to viewers in a number of formats including interactive formats.

The present invention also provides foreign translation systems and methods that provide end-to-end audio transcription and language translation of live events (i.e., from audio source to intended viewer), streamed over an electronic communication network. Such systems and methods include streaming text of the spoken word, complete accumulative transcript, the ability to convert text back into audio in any desired language, and comments/ questions handling submitted by viewers of the multimedia information (e.g., returned to each viewer in their selected language). In some embodiments, text streaming occurs through independent encoded media streaming (e.g., separate IP ports). The information is provided in any desired format (e.g., MICROSOFT, REAL, QUICKTIME, etc.). In some embodiments, real-time translations are provided in multiple languages simultaneously or concurrently (e.g., each viewer selects/or changes their preferred language during the event).

The present invention also provides audio to text conversion with high accuracy in short periods of time. For example, the present invention provides systems and methods for accurate transcription of live events to 95-98%, and accurate transcription of any event to 100% within a few hours of event completion.

The systems and methods of the present invention may be applied to interactive formats including talk-show formats. For example, as described in more detail below, in some embodiments, the systems and methods of the present invention provide an electronic re-creation of the television talk-show model over the web without requiring the participants to use or own any technology beyond a telephone and a web connected device (e.g., a personal computer). Talk-show participation by invited guests or debatees may be conducted through the web. In some embodiments, the system and methods employ web-based, moderator and participant controls and/or web-based call-in “screener” controls. In some embodiments, viewer interaction is handled via email, comment/question queue maintained by a database, and/or phone call- ins. In some preferred embodiments of the present invention, real-time language translation in multiple languages is applied to allow participation of individuals, independent of their language usage. Streaming multimedia information provided in the interactive format includes, as desired, graphical or video slides, images, and/or video.

The present invention further provides systems and methods for complete re-creation of the classroom teaching model, including live lectures (audio and video), presentation slides, slide notes, comments/questions (via email, chat, and/or live call-ins), streaming transcript/foreign translations, complete lecture transcript, streaming videos, and streaming PC screen capture demos with audio voice-over.

For use in such applications, the present invention provides a system comprising a processor, said processor configured to receive multimedia information and encode a plurality of information streams comprising a separately encoded first information stream and a separately encoded second information stream from the multimedia information, said first information stream comprising audio information and said second information stream comprising text information (e.g., text transcript information generated from the audio information). The present invention is not limited by the nature of the multimedia information. Multimedia information includes, but is not limited to, live event audio, televised audio, speech audio, and motion picture audio. In some embodiments, the multimedia information comprises information from a plurality of distinct locations (e.g., distinct geographic locations).

In some embodiments, the system further comprises a speech to text converter, wherein the speech to text converter is configured to produce text from the multimedia information and to provide the text to the processor. The present invention is not limited by the nature of the speech to text converter. In some embodiments, the speech to text converter comprises a stenograph (e.g., operated by a stenographer). In other embodiments, the speech to text converter comprises voice recognition software. In preferred embodiments, the speech to text converter comprises an error corrector configured to confirm text accuracy prior to providing the text to the processor.

In some embodiments, the processor further comprises a security protocol. In some preferred embodiments, the security protocol is configured to restrict participants and viewers from controlling the processor (e.g., a password protected processor). In other embodiments, the system further comprises a resource manager (e.g., configured to monitor and maintain efficiency of the system).

In some embodiments, the system further comprises a conference bridge configured to receive the multimedia information, wherein the conference bridge is configured to provide the multimedia information to the processor. In some embodiments, the conference bridge is configured to receive multimedia information from a plurality of sources (e.g., sources located in different geographical regions). In other embodiments, the conference bridge is further configured to allow the multimedia information to be viewed (e.g., is configured to allow one or more viewers to have access to the systems of the present invention).

In some embodiments, the system further comprises a delay component configured to receive the multimedia information, delay at least a portion of the multimedia information, and send the delayed portion of the multimedia information to the processor.

In some embodiments, the system further comprises a text to speech converter configured to convert at least a portion of the text information to audio.

In still other embodiments, the system further comprises a language translator configured to receive the text information and convert the text information from a first language into one or more other languages.

In some embodiments, the processor is further configured to transmit a viewer output signal comprising the second information stream (e.g., transmit information to one or more viewers). In some embodiments, the viewer output signal further comprises the first information stream. In preferred embodiments, the viewer output signal is compatible with a multimedia software application (e.g., a multimedia software application on a computer of a viewer).

In some embodiments, the system further comprises a software application configured to display the first and/or the second information streams (e.g., allowing a viewer to listen to audio, view video, and view text). In some preferred embodiments, the software application is configured to display the text information in a distinct viewing field. In some embodiments, the software application comprises a text viewer. In other embodiments, the software application comprises a multimedia player embedded into a text viewer. In some preferred embodiments, the software application is configured to allow the text information to be printed.

The present invention further provides a system for interactive electronic communications comprising a processor, wherein the processor is configured to receive multimedia information, encode an information stream comprising text information, send the information stream to a viewer, wherein the text information is synchronized with an audio or video file, and receive feedback information from the viewer.

The present invention also provides methods of using any of the systems disclosed herein. For example, the present invention provides a method for providing streaming text information, the method comprising providing a processor and multimedia information comprising audio information; and processing the multimedia information with the processor to generate a first information stream and a second information stream, said first information stream comprising the audio information and said second information stream comprising text information, said text information corresponding to the audio information.

In some embodiments, the method further comprises the step of converting the text information into audio. In other embodiments, the method further comprises the step of translating the text information into one or more different languages. In still other embodiments, the method further comprises the step of transmitting the second information stream to a computer of a viewer. In other embodiments, the method further comprises the step of receiving feedback information (e.g., questions or comments) from a viewer.

The present invention further provides systems and methods for providing translations for motion pictures, television shows, or any other serially encoded medium. For example, the present invention provides methods for the translation of audio dialogue into another language that will be represented in a form similar to subtitles. The method allows synchronization of the subtitles with the original audio. The method also provides a hardcopy or electronic translation of the dialogue in a scripted form. The systems and methods of the present invention may be used to transmit and receive synchronized audio, video, timecode, and text over a communication network. In some embodiments, the information is encrypted and decrypted to provide anti-piracy or theft of the material. Using the methods of the present invention, a dramatic reduction in the time between a domestic motion picture release and foreign releases is achieved.

The present invention further provides a system comprising: a conference bridge configured to receive audio information; a speech-to-text converter configured to receive audio information from the conference bridge and to convert at least a portion of the audio information into text information; and a processor configured to receive the text information from the speech-to- text converter and to encode a text information stream. In some embodiments, one or more of the transmissions (e.g., receipt of information by the conference bridge, transmission of information from the conference bridge to the speech-to- text converter, transmission of information from the speech-to-text converter to the processor, or transmission of text information streams from the processor) is carried out by a wireless communication system. In some embodiments, the processor is further configured to transmit the text information stream to a computer system of a viewer. In some preferred embodiments, the processor is further configured to transmit a text viewer software application to the viewer. In still further preferred embodiments, the processor is further configured to receive feedback information from the viewer.

What is claimed is:

1. A system for automated audio transcription, translation and transfer for online meeting, wherein the aforesaid system comprises:
(a) real-time conversation mode with auto language detection which is used to record and stream voice input;
(b) speech-to-text API that automatically recognize the language of input voice stream and segment it in specific time intervals, recognize the language within each segment and then provide corresponding text in real time;
(c) translation API that takes returned output from Speech-to-Text API as input and translates it to user selected language;
(d) text-to-speech framework to provide audio for translated text if the framework supports the selected user language and takes the outputted text of the translation API and returns its corresponding audio in the user selected language;
(e) saving recording API that saves the current translation log and binds it to the user.

2. The system as claimed in claim 1 wherein, the user of the aforesaid system takes voice input from the phone’s microphone, sends it to an API that recognizes language and transforms it into text, then translates the text to user preferred language and displays the returned translated text in a scrollable view.

3. The system as claimed in claim 1 wherein, whenever the transcript view is updated, the newly added text will be passed to a Text-to-Speech API that will return the audio for the inputted text in the user preferred language.

4. The system as claimed in claim 1 wherein, the user of the aforesaid system can view the saved transcription logs on demand.

5. The system as claimed in claim 1 wherein, the user of the aforesaid system can play the audio of the saved recordings as well in addition to the current transcription log.
